(19) United States
(12) Patent Application Publication
(10) Pub. No.: US 2020/0149235 A1
(43) Pub. Date: May 14, 2020

(54) Barrier Systems and Methods

(71) Applicant: Fiedor Bis, Chorzów (PL)

(72) Inventor: Zofia Wawrzynek, Góra Siewierska (PL)

(21) Appl. No.: 16/185,626

(22) Filed: Nov. 9, 2018

(51) Int. Cl. E01F 15/08; E01F 13/02; E01F 15/00; F16B 5/02

(52) U.S. Cl. CPC E01F 15/08; E01F 15/083; F16B 5/02; E01F 13/02; E01F 15/006; E01F 15/088

(57) ABSTRACT

In an example, a system of road barriers includes a corner barrier segment, which includes a central member, a first member extending from the central member, and second member extending from the central member. The first member and the second member are configured to rotate about an axis of the central member relative to each other. The system also includes a first barrier segment coupled to the first member of the corner barrier segment via fasteners on both the first barrier segment and the first member. The system further includes a second barrier segment coupled to the second member of the corner barrier segment via fasteners on both the second barrier segment and the second member.

### FIELD

The present disclosure generally relates to barrier systems and methods that provide for, among other things, traffic control on roadways.

### BACKGROUND

Temporary road barrier systems allow for traffic control and general safety while, for example, a road undergoes construction. Such road barrier systems may generally include a number of road barrier segments positioned next to each another.

### SUMMARY

In an example, a barrier system is described. The barrier system includes a corner barrier segment. The corner barrier segment includes a central member, a first member coupled to the central member, and a second member coupled to the central member. The first member and the second member may be configured to rotate about an axis of the central member relative to each other. The first member includes a first fastener. The second member includes a second fastener. The system further includes a first barrier segment coupled to the first member via the first fastener on the first member of the corner barrier segment and a third fastener the first barrier segment. The system also includes a second barrier segment coupled to the second member via the second fastener on the second member of the corner barrier segment and a fourth fastener on the second barrier segment.

In another example, a method of configuring a system of road barriers is described. The method includes positioning a corner barrier segment in a first configuration, the corner barrier segment including a central member and first and second members which may rotate about an axis of the central member relative to each other. The first configuration defines a first angle between the first member and the second member about the central member. The method also includes rotating, about the axis of the central member, at least one of the first or the second member to position the corner barrier segment in a second configuration in which the first member and the second member define a second angle, which is different than the first angle. The method further includes coupling the first member of the corner barrier segment to a first barrier segment. The method also includes coupling the second member of the corner barrier segment to a second barrier segment.

The features, functions, and advantages that have been discussed can be achieved independently in various embodiments or may be combined in yet other embodiments further details of which can be seen with reference to the following description and drawings.

### BRIEF DESCRIPTION OF THE FIGURES

The novel features believed characteristic of the illustrative embodiments are set forth in the appended claims. The illustrative embodiments, however, as well as a preferred mode of use, further objectives and descriptions thereof, will best be understood by reference to the following detailed description of an illustrative embodiment of the present disclosure when read in conjunction with the accompanying drawings, wherein:

FIG. 1 illustrates a block diagram of an example barrier system, according to an example embodiment.

FIG. 2A illustrates a top view of a corner barrier segment, according to an example embodiment.

FIG. 2B illustrates an elevation view of the corner barrier segment shown in FIG. 2A, according to an example embodiment.

FIG. 2C illustrates a top view of a corner barrier segment, according to an example embodiment.

FIG. 2D illustrates a top view of a corner barrier segment, according to an example embodiment.

FIG. 2E illustrates a partial isometric view of a first lateral side of a corner barrier segment, according to an example embodiment.

FIG. 2F illustrates a partial isometric view of a second lateral side of a corner barrier segment, according to an example embodiment.

FIG. 3A illustrates an isometric view of a barrier segment, according to an example embodiment.

FIG. 3B illustrates a side elevation view of the barrier segment shown in FIG. 3A, according to an example embodiment.

FIG. 3C illustrates an end elevation view of the barrier segment shown in FIG. 3A, according to an example embodiment.

FIG. 4A illustrates an isometric view of a sloped barrier segment, according to an example embodiment.

FIG. 4B illustrates a side elevation view of the sloped barrier segment shown in FIG. 4A, according to an example embodiment.

FIG. 4C illustrates an end elevation view of an example embodiment of a sloped barrier segment shown in FIG. 4A, according to an example embodiment.

FIG. 5A illustrates a side elevation view of an assembled barrier system, according to an example embodiment.

FIG. 5B illustrates a top view of the barrier system shown in FIG. 5A, according to an example embodiment.

FIG. 6A illustrates an isometric view of a receptacle fastener, according to an example embodiment.

FIG. 6B illustrates an isometric view of a hook fastener, according to an example embodiment.

FIG. 6C illustrates an elevation view of the receptacle fastener shown in FIG. 6A and the hook fastener shown in FIG. 6B, according to an example embodiment.

FIG. 7A illustrates an isometric view of a receptacle fastener, according to an example embodiment.

FIG. 7B illustrates an isometric view of a receptacle fastener, according to an example embodiment.

FIG. 7C illustrates an elevation view of the receptacle fastener shown in FIG. 7A and the receptacle fastener shown in FIG. 7B, according to an example embodiment.

FIG. 8 illustrates an elevation view barrier segment with equipment according to an example embodiment.

FIG. 9 illustrates a flow chart of a barrier method, according to an example embodiment.

FIG. 10 illustrates a flow chart of a barrier method, according to an example embodiment.

FIG. 11 illustrates a flow chart of a barrier method, according to an example embodiment.

FIG. 12 illustrates a flow chart of a barrier method, according to an example embodiment.

FIG. 13 illustrates a flow chart of a barrier method, according to an example embodiment.

### DETAILED DESCRIPTION

Disclosed embodiments will now be described more fully hereinafter with reference to the accompanying drawings, in which some, but not all of the disclosed embodiments are shown. Indeed, several different embodiments may be described and should not be construed as limited to the embodiments set forth herein. Rather, these embodiments are described so that this disclosure will be thorough and complete and will fully convey the scope of the disclosure to those skilled in the art. For instance, elements, arrangements, and functions may be added, removed, combined, distributed, or otherwise modified.

I. Overview

The barrier systems and methods of the present disclosure provide for road barrier and traffic control operations. Existing road barrier systems present a number of challenges. As an example, existing road barrier systems typically consist of several linear segments placed adjacent to one another. Using such existing road barrier systems, it can be challenging to traverse obstacles (e.g., a tree, a light post, a road sign, a traffic signal) along a path of the road barrier system. Additionally, for instance, it can be challenging to position road barrier segments along a curved portion of the path of the road barrier system. Specifically, existing systems can result in discontinuities and/or inefficient use of space and/or materials to traverse obstacles and/or position the road barrier system along a curved portion of a path of the road barrier system.

The systems and methods of the present disclosure can beneficially address, among other things, the challenge described above. Within examples, the systems and methods of the present disclosure provide for a barrier system including a corner barrier segment, which can improve the positioning of road barrier segments along a non-linear path and/or around obstacles in a desired path of the barrier system.

In one example, the systems and methods described in the present disclosure allow for a corner barrier segment to couple to at least two road barrier segments. The corner barrier includes a first member and a second member, which are rotatable about a central member relative to each other. Rotation of the first and second members allows for flexibility of the positioning of the two road barrier segments.

II. Example System

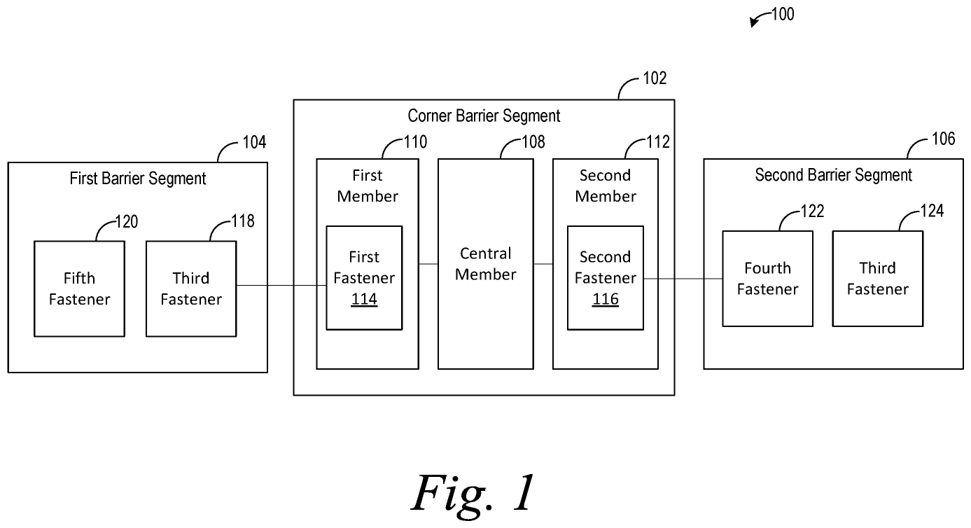

Referring to FIG. 1, a simplified block diagram of a barrier system 100 is illustrated according to an example embodiment. The barrier system 100 includes a corner barrier segment 102 coupled to a first barrier segment 104 and a second barrier segment 106. For ease of illustration, FIG. 1 depicts the barrier system 100 including three barrier segments coupled to each other (i.e., the corner barrier segment 102, the first barrier segment 104, and the second barrier segment 106). However, the barrier system 100 can include a lesser quantity or a greater quantity of barrier segments coupled to each other in additional or alternative examples. For instance, a relatively large quantity of barrier segments may be utilized on major roadways (e.g., interstates) to close a lane of traffic over a relatively long distance (e.g., one or more miles). Alternatively, a relatively small quantity of barrier segments may be utilized on smaller roads (e.g., a street in a subdivision) and/or over a relatively short distance, for example, to divert traffic away from a pothole.

As shown in FIG. 1, the corner barrier segment 102 can include a central member 108, a first member 110, and a second member 112. The first member 110 is coupled to the central member 108 and includes a first fastener 114. The second member 112 is also coupled to the central member 108 and includes a second fastener 116.

As described in further detail below, the first fastener 114 can couple the first member 110 to the first barrier segment 104. For example, the first fastener 114 can couple to a third fastener 118 of the first barrier segment 104 to couple the first member 110 to the first barrier segment 104. Similarly, the second fastener 116 can couple the second member 112 to the second barrier segment 106. For example, the second fastener 116 can couple to a fourth fastener 122 of the second barrier segment 106 to couple the second member 112 to the first barrier segment 104.

Additionally, as described in further detail below, the first member 110 and the second member 112 are rotatable, about an axis of the central member 108 relative to each other. As such, within examples, the first member 110 and the second member 112 of the corner barrier segment 102 can define an angle about the central member 108. In one example, the first member 110 and the second member 112 may define an angle about the central member 108 selected from a plurality of angles between approximately 30 degrees and approximately 330 degrees. In another example, the first member 110 and the second member 112 may define an angle about the central member 108 selected from a plurality of angles between approximately 90 degrees and approximately 270 degrees. By rotating the first member 110 relative to the second member 112, the corner barrier segment 102 can help to arrange the barrier system 100 around obstacles (e.g., a light post) and/or a non-linear portion of a path of the barrier system 100 (e.g., a curved portion of the path).

In one example, the corner barrier segment 102, the first barrier segment 104, and/or the second barrier segment 106 can be made from a polyethylene material. For instance, the polyethylene material can be in the form of a micro-granulate or powder having a density that is equal to or greater than approximately 0.935 grams per cubic centimeter. Additionally, for instance, the material can be thermally stabilized against ultraviolet (UV) radiation. Also, within examples, the material can have a stiffness with a Young's modulus that is greater than or equal to 645 megapascal (MPa) and a melt flow index (MFI) flow rate between approximately 1.0 gram per minute and approximately 8.0 grams per minute at a load of approximately 21.6 Newtons. Other materials having different characteristics may also be used in additional or alternative examples.

A. Example Corner Barrier Segments

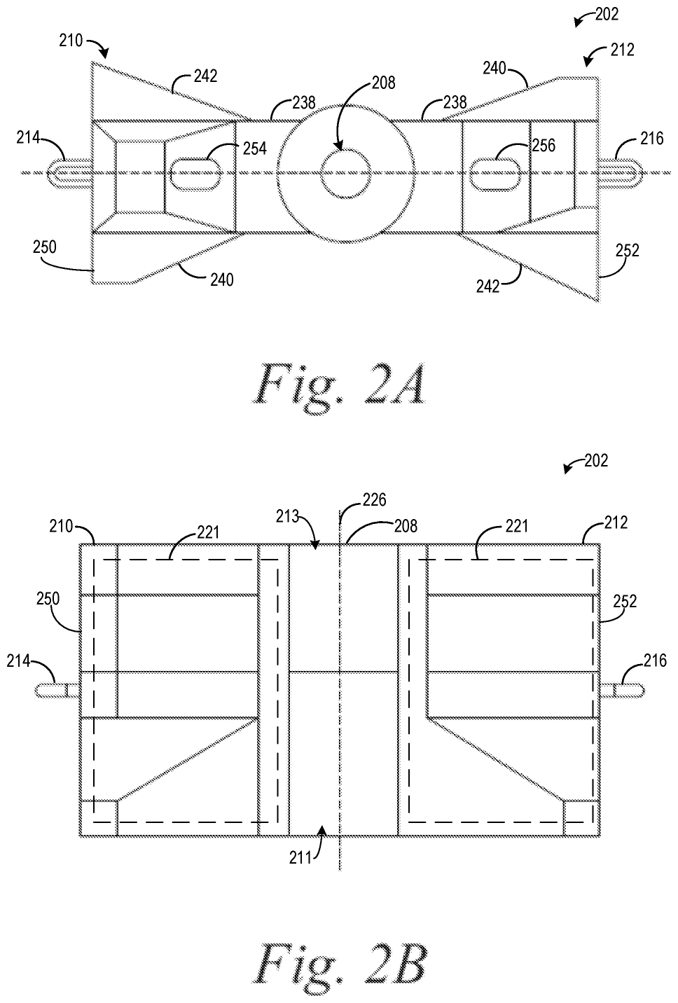

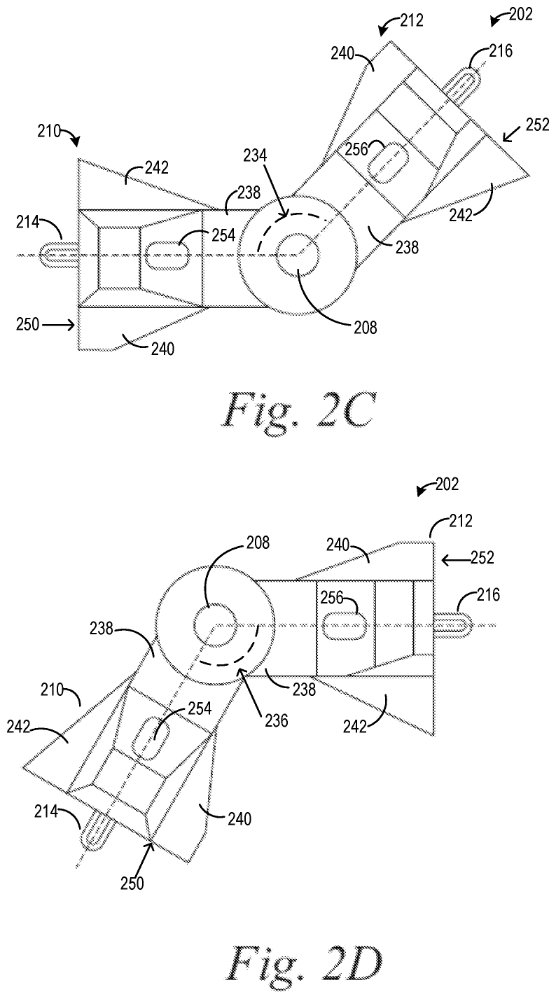

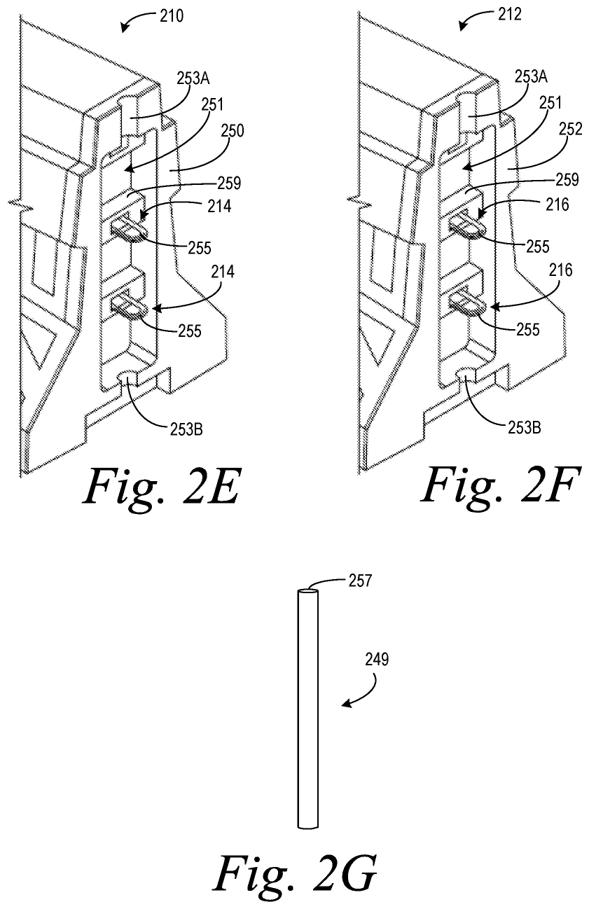

Referring to FIGS. 2A-2B, a corner barrier segment 202 is illustrated according to an example embodiment. Specifically, FIG. 2A illustrates a top view of the corner barrier segment 202 and FIG. 2B illustrates an elevation view of the corner barrier segment 202 according to the example embodiment.

As shown in FIGS. 2A-2B, the corner barrier segment 202 includes a central member 208, a first member 210, and a second member 212 as described above with respect to FIG. 1. For example, as described above, the first member 210 and the second member 212 can be coupled to the central member 208 such that the first member 210 and the second member 212 rotate about an axis 226 of the central member 208 relative to each other.

In one example, the central member 208 can include a pin that extends along the axis 226. The first member 210 can include a first arm portion 211 defining a bore extending in the direction of the axis 226, and the second member 212 can include a second arm portion 213 defining a bore extending in the direction of the axis 226. In this arrangement, the pin of the central member 208 can extend through the bore of the first arm portion 211 and the bore of the second arm portion 213. In this way, the pin of the central member 208 can couple the first member 210 and the second member 212 such that the first member 210 and the second member 212 can rotate about the axis 226.

In an example embodiment, the central member 208 may be substantially cylindrical. However, the central member 208 can have a different shape in alternative examples. More generally, the central member 208 can have a shape that allows the first member 210 and the second member 212 to rotate about the axis 226 of the central member 208.

Within examples, the first member 210 can have a narrower width at the central member 208 and a wider width at a first lateral side 250 of the corner barrier segment 202 to assist with rotation of the first member 210 at the central member 208 and improve stability at the first lateral side 250. For instance, in FIGS. 2A-2B, the first member 210 includes a substantially rectangular portion 238 extending from the central member 208, and a triangular portion 242 and a trapezoidal portion 240 near the first lateral side 250 of the first member 210. Due to the increased width of the triangular portion 242 and the trapezoidal portion 240, the triangular portion 242 and trapezoidal portion 240 can assist in providing stability to the corner barrier segment 202.

Similarly, the second member 212 can have a narrower width at the central member 208 and a wider width at a second lateral side 252 of the corner barrier segment 202 to assist with rotation of the first member 210 at the central member 208 and improve stability at the second lateral side 252. For instance, in FIGS. 2A-2B, the second member 212 includes a substantially rectangular portion 238 extending from the central member 208, and a triangular portion 242 and a trapezoidal portion 240 near the second lateral side 252 of the second member 212. As noted above, due to the increased width of the triangular portion 242 and the trapezoidal portion 240, the triangular portion 242 and trapezoidal portion 240 can provide stability of the corner barrier segment 202.

Although the first member 210 and the second member 212 each include a trapezoidal portion 240 and a triangular portion 242 in FIGS. 2A-2B, the first member 210 and/or the second member 212 can include two triangular portions 242 and/or two trapezoidal portions 244 in other examples. Other examples and configurations are also possible.

Further, in some examples, an external surface on both the first member 210 and the second member 212 may define an internal cavity 221 such that the first member 210 and the second member 212 are hollow. The first member 210 and the second member 212 may also include one or more apertures 254, 256 in an upper portion of the first member 210 and the second member 212. As shown in FIG. 2A, the apertures 254, 256 can be located on a top portion of the first member 210 and the second member 212. In other examples, the apertures 254, 256 can be additionally or alternatively located on the first lateral side 250, the second lateral side 252, and/or one or more side walls extending between the first lateral side 250 and the second lateral side 252 on first member 210 and/or the second member 212.

In general, the apertures 254, 256 provide access to the internal cavity 221 of the first member 210 and the second member 212 such that the first member 210 and the second member 212 can be filled with a fill material (i.e., the apertures 254, 256 can be used as a fill port). As examples, the fill material can include water, concrete, sand, a foam material (e.g., polyurethane foam), and/or gravel. In one implementation, the apertures 254, 256 can have a size and a shape that is configured to receive a standard concrete pump hose (e.g., the apertures 254, 256 can have a diameter of approximately 160 millimeters to receive a standard concrete pump hose). By receiving the hose of a system that supplies the fill material, the corner barrier segment 202 can beneficially reduce (or eliminate) splashing of the fill material onto the exterior of the corner barrier segment 202.

Within examples, the first member 210 and the second member 212 can each be a respective monolithic structure (e.g., made from a single part construction). This can help to mitigate (or prevent) distention of the first member 210 and/or the second member 212 while filling the corner barrier segment 202 with the fill material.

In some examples, the apertures 254, 256 may also each include a cap (not shown). In general, the caps can inhibit access to the internal cavities 221 of the first member 210 and the second member 212. In one implementation, the caps can provide a seal for the internal cavities 221 of the first member 210 and the second member 212 from an external environment. However, in other examples, one or more of the caps can cover the apertures 254, 256 without providing a seal.

As noted above, the corner barrier segment 202 is configured such that the first member 210 can rotate, about the axis 226, relative to the second member 212. Accordingly, the corner barrier segment 202 can be arranged in a plurality of configurations in which the first member 210 and the second member 212 define respective angles about the central member 208.

FIG. 2C illustrates the corner barrier segment 202 in a first configuration and FIG. 2D illustrates the corner barrier segment 202 in a second configuration, according to an example embodiment. As shown in FIG. 2C, the corner barrier segment 202 is in the first configuration in which the first member 210 and the second member 212 define a first angle 234 about the central member 208. The first member 210 and/or the second member 212 can be rotated about the central member 208 to transition the corner segment from the first configuration shown in FIG. 2C to the second configuration shown in FIG. 2D. As shown in FIG. 2D, in the second configuration, the first member 210 and the second member 212 define a second angle 236, different than the first angle 234, about the central member 208. This is can help arrange the barrier system 100 around obstacles (e.g., a light post, a traffic sign, a tree, etc.) and/or arrange the barrier system 100 along a non-linear path.

As shown in FIGS. 2A-2D, the first member 210 includes a first fastener 214 and the second member 212 includes a second fastener 216. FIG. 2E shows a partial perspective view of the first lateral side 250 of the first member 210, including the first fastener 214 and FIG. 2F shows a partial perspective view of the second lateral side 252 of the second member 212, including the second fastener 216, according to an example embodiment. Additionally, FIG. 2G shows a bolt 249 for use with the first fastener 214 and/or the second fastener 216, according to an example embodiment.

As shown in FIG. 2E, the first fastener 214 can be coupled to a recessed portion 251 of the first lateral side 250. Additionally, the first lateral side 250 can include a top groove 253A above the recessed portion 251 and a bottom groove 253B below the recessed portion 251. Further, the first fastener 214 can include a plurality of loops 255 (i.e., receptacles) that extend outwardly from the recessed portion 251. As shown in FIG. 2E, the loops 255 can each define a fastener aperture that is axially aligned with the top groove 253A and the bottom groove 253B. As described in further detail below, this alignment of the loops 255, the top groove 253A, and the bottom groove 253B can provide for the bolt 249 to be positioned in the top groove 253A, the fastener apertures of the loops 255, and the bottom groove 253B to couple the first member 210 to an adjacent barrier segment (e.g., the first barrier segment 104).

Within examples, a corresponding fastener on an adjacent barrier segment (e.g., the third fastener 118 of the first barrier segment 104) can extend into the recessed portion 251 of the first lateral side 250. This can help to reduce a gap between first lateral side 250 of the corner barrier segment 202 and the adjacent barrier segment when coupled to each other. For instance, in one implementation, the adjacent barrier segment can include corresponding loops that overlap with the loops 255 of the first fastener 214 to define an eye through which the bolt 249 can be inserted to couple the corner barrier segment 202 to the adjacent barrier segment. Additionally, for example, the top groove 253A and the bottom groove 253B can abut against similar grooves of the adjacent barrier segment to define a passage for inserting the bolt 249 through the loops 255.

As shown in FIG. 2F, the second fastener 216 can be coupled to a recessed portion 251 of the second lateral side 252. Additionally, the second lateral side 252 can include a top groove 253A above the recessed portion 251 and a bottom groove 253B below the recessed portion 251. Further, the second fastener 216 can include a plurality of loops 255 that extend outwardly from the recessed portion 251. As shown in FIG. 2F, the loops 255 can each define a fastener aperture that is axially aligned with the top groove 253A and the bottom groove 253B. As described in further detail below, this alignment of the loops 255, the top groove 253A, and the bottom groove 253B can provide for the bolt 249 to be positioned in the top groove 253A, the fastener apertures of the loops 255, and the bottom groove 253B to couple the second member 212 to an adjacent barrier segment (e.g., the second barrier segment 106).

Within examples, a corresponding fastener on an adjacent barrier segment (e.g., the fourth fastener 122 of the second barrier segment 106) can extend into the recessed portion 251 of the second lateral side 252. This can help to reduce a gap between second lateral side 252 of the corner barrier segment 202 and the adjacent barrier segment when coupled to each other. For instance, in one implementation, the adjacent barrier segment can include corresponding loops that overlap with the loops 255 of the second fastener 216 to define an eye through which the bolt 249 can be inserted to couple the corner barrier segment 202 to the adjacent barrier segment. Additionally, for example, the top groove 253A and the bottom groove 253B can abut against similar grooves of the adjacent barrier segment to define a passage for inserting the bolt 249 through the loops 255.

Although the first fastener 214 and the second fastener 216 can include the loops 255 and be coupled to an adjacent barrier segment by the bolt 249, the first fastener 214 and/or the second fastener 216 can additionally or alternatively include non-loop type fasteners and/or be coupled to the adjacent barrier segment by means other than the bolt 249 in other examples. For example, as described further below, the first fastener 214 and/or the second fastener 216 can include one or more hooks that couple with corresponding loops. Additionally or alternatively, the loops 255 of the first fastener 214 and/or the second fastener 216 can be coupled with corresponding hooks on the adjacent barrier segment(s) instead of the bolt 249 in other examples. In one implementation, the loops 255 can be formed from S235JR steel and/or treated (e.g., coated) with a layer of anti-corrosion material.

In some examples, the first fastener 214 and/or the second fastener 216 can be permanently affixed to the first member 210. For instance, the first fastener 214 and/or the second fastener 216 can be coupled to the corner barrier segment 202 by, for example, one or more welds, screws, and/or bolts. In FIGS. 2E-2F, for example, the loops 255 are coupled to the first lateral side 250 and the second lateral side 252 by a tongue member 259. The tongue member 259 can help to reinforce and strengthen the coupling of the loops 255 to the corner barrier segment 202.

In another example, the first fastener 214 and/or the second fastener 216 can be removably coupled to the corner barrier segment 202 by, for instance, a threaded connection on the first lateral side 250 of the first member 210 and/or the second lateral side 252 of the second member 212. Further, in some examples, the first fastener 214 and/or the second fastener 216 can each include a single fastener. In other examples, the first fastener 214 and/or the second fastener 216 can each include a plurality of fasteners.

In one example, the bolt 249 can be a ribar structure. Also within examples, the bolt 249 can include a protective covering 257 on a top end of the bolt 249. For instance, the protective covering 257 can be made from a foam material to protect the bolt.

B. Example First and Second Barrier Segments

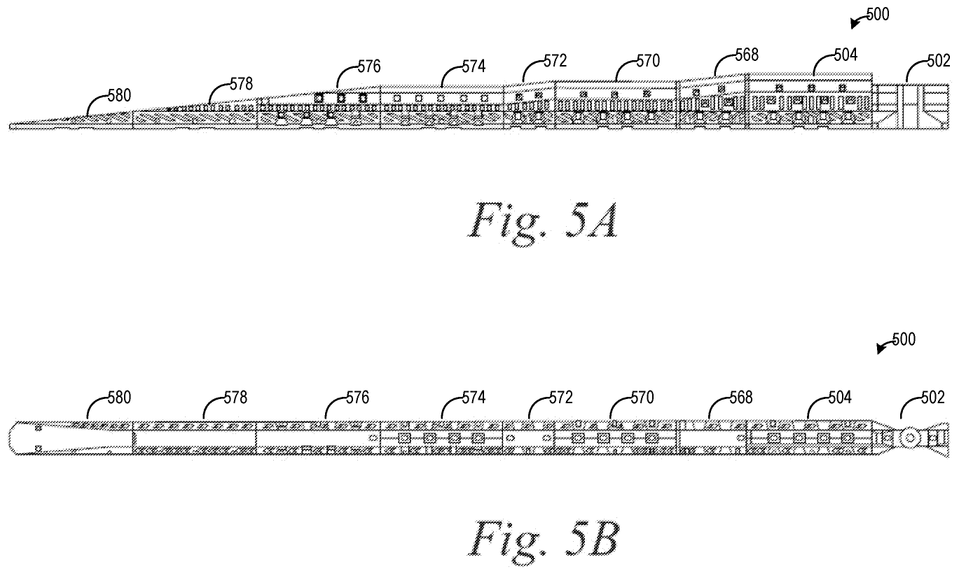

Within examples, the corner barrier segment 202 can be coupled to a variety of different first barrier segments 104 and/or second barrier segments 106. The following is a description of example barrier segments that can be coupled to the corner barrier segment 202 within examples. However, additional or alternative barrier segments are further illustrated and described below with respect to FIGS. 5A-5B, which can also be coupled to the corner barrier segment 202 within examples of the present disclosure.

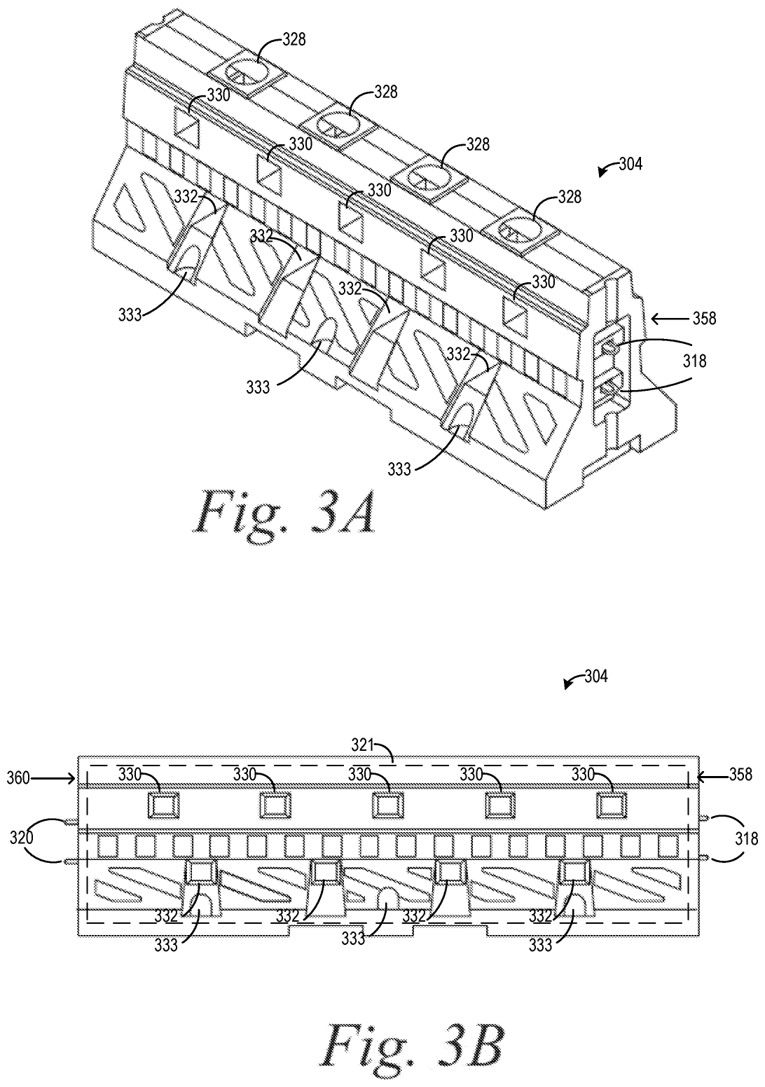

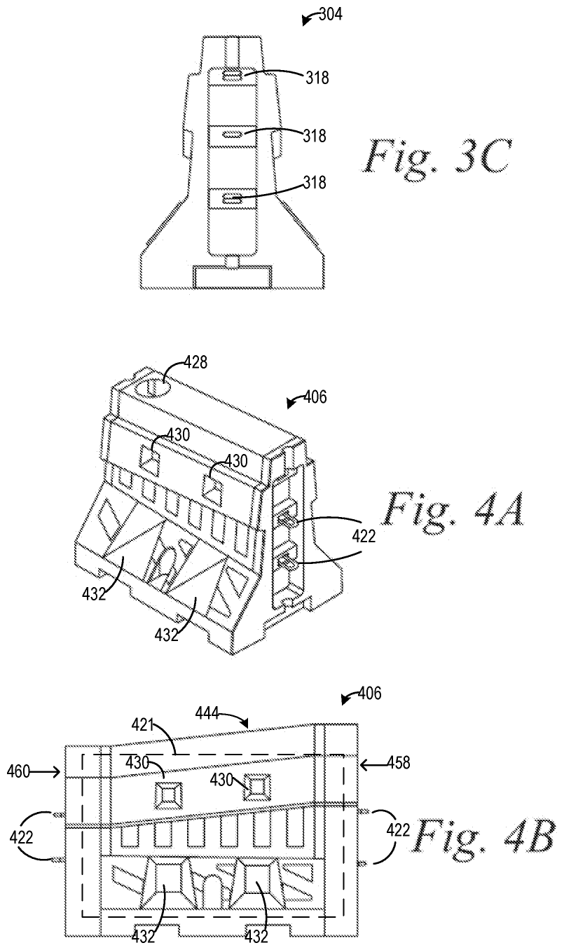

Referring to FIGS. 3A-3C, a first barrier segment 304 is illustrated according to an example embodiment. Specifically, FIG. 3A illustrates an isometric view of the first barrier segment 304, FIG. 3B illustrates a side elevation view of the first barrier segment 304, and FIG. 3C illustrates an end elevation view of the first barrier segment 304.

As shown in FIGS. 3A-C, the first barrier segment 304 includes a third fastener 118 on a first end 358, a fifth fastener 320 on a second end 360, and one or more apertures 328 on an upper portion of the first barrier segment 304. Further, in some examples, an external surface on the first barrier segment 304 may define an internal cavity 321 such that the first barrier segment 304 is hollow. As such the aperture(s) 328 can provide access to the internal cavity 321 to facilitate filling the first barrier segment 304 with the fill material.

The first barrier segment 304 can include one or more upper channels 330 at the upper portion of the first barrier segment 304. In an example, the upper channels 330 can help to protect the first barrier segment 304 against bloating while filling the first barrier segment 304 with the fill material. For instance, in one implementation, a threaded rod can be placed in each upper channel 330 and nuts can be screwed onto opposing ends of the threaded rod. As the fill material is supplied to the internal cavity 321, the threaded rods (secured by the nuts) in the upper channels 330 can help to mitigate (or prevent) bloating as a result of the internal pressure applied by the fill material on the walls of the first barrier segment 304. Also, within examples, the upper channels 330 can provide structures for coupling equipment such as, for example, reflector lights and/or signs.

As shown in FIGS. 3A-3B, the first barrier segment 304 can additionally include one or more recessed pockets 332 at a lower portion of the first barrier segment 304. The recessed pockets 332 can also help to prevent distension of the first barrier segment 304 while filling the internal cavity 321 with the fill material. The recessed pockets 332 can additionally or alternatively help to improve drainage by allowing for water and/or snow melt to flow through the lower portion of the first barrier segment 304.

Within examples, the first barrier segment 304 can each be a monolithic structure (e.g., made from a single part construction). This can help to mitigate (or prevent) distention of the first barrier segment 304 while filling the first barrier segment 304 with the fill material.

Additionally, as shown in FIGS. 3A-3B, the first barrier segment 304 can include one or more notches 333 at the lower portion of the first barrier segment 304. The notches 333 can facilitate anchoring the first barrier segment 304, for example, by a chemical anchor.

The third fastener 318 of the first barrier segment 304 can be coupled to the first end 358 of the first barrier segment 304, and the fifth fastener 320 on the first barrier segment 304 can be coupled to the second end 360 of the first barrier segment 304 in a manner similar to that described above with respect to FIGS. 2E-2F. For example, the third fastener 318 and/or the fifth fastener 320 can include one or more loops 355 coupled to a recessed portion 351 between a top groove 353A and a bottom groove 353B.

As noted above, the first barrier segment 304 can include one or more apertures 328 in the upper portion of the first barrier segment 304. Additionally, as noted above, the apertures 328 provide access to the internal cavity 321 of the first barrier segment 304 such that the first barrier segment 304 can be filled with a fill material (i.e., the aperture 328 can be used as a fill port). As illustrated in FIG. 3A, in some embodiments, the apertures 328 may be located on the top of the first barrier segment 304. Alternatively, the apertures 328 may be located on either lateral side or either the first end 358 or the second end 360 of the first barrier segment 304. In some examples, the apertures 328 may also include a cap (not shown). The cap may provide a seal for the internal cavity of the first barrier segment 304 from an external environment and/or may not seal the internal cavity.

Within examples, equipment can be positioned in one or more of the apertures 328 such that the equipment extends from the internal cavity 321 of the first barrier segment 304 to an external environment. In one example, the equipment can be coupled to the fill material in the internal cavity 321 to assist in stabilizing the equipment on the first barrier segment 304. Equipment may include, for example, any combination of one or more of an atmospheric detection device (e.g., measuring an amount of exhaust gases), a radar detection device, a vehicle counting device, or a road traffic control device (e.g., a stop sign, a traffic light, a construction sign, a traffic sign, etc.). Many other examples of equipment are possible.

In examples where the first barrier segment 304 is attached to the first member 210 via the first fastener 214 and the third fastener 318, rotation of the first member 210 about an axis 226 of the central member 208 affects placement of the first barrier segment 304 within the road barrier system 100. Additionally, this may affect placement any other barrier segments attached to the first barrier segment 304 in the road barrier system 100. For example, the corner barrier segment 202 may be in a first configuration where the first member 210 and the second member 212 define a first angle 234 about the central member 208. The first member 210 may be rotated to a second configuration defining a second angle 236, different from the first angle 234, about the central member 208. This is can help arrange the road barrier system 100 around obstacles (e.g., a light post, a traffic sign, a tree, etc.).

Further, regarding the shape of the first barrier segment 304, the lower portion of the first barrier segment 304 may be wider than the upper portion of the first barrier segment 304. The wider lower portion can help provide stability to the first barrier segment 304.

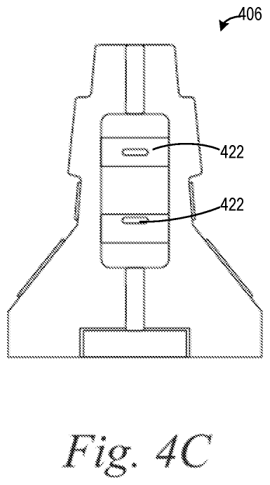

Referring to FIGS. 4A-4C, a second barrier segment 406 is illustrated according to an example embodiment. Specifically, FIG. 4A illustrates an isometric view of the second barrier segment 406, FIG. 4B illustrates a lateral elevation view of the second barrier segment 406, and FIG. 4C illustrates an end elevation view of the second barrier segment according to an example embodiment.

As shown in FIGS. 4A-4C, the second barrier segment 406 is substantially similar to the first barrier segment 304, except the second barrier segment 406 has a relatively shorter length and the second barrier segment 406 has a sloped top portion 444. For example, similar to the first barrier segment 304, the second barrier segment 406 includes a fourth fastener 422 on a first end of 458 of the second barrier segment 406, a sixth fastener 424 on a second end 460 of the second barrier segment 406, one or more recessed pockets 432 on a lower portion of a first lateral side 462 and/or a second lateral side 464 of the second barrier segment 406, one or more upper channels 430 on an upper portion of the second barrier segment 406, and one or more apertures 428 in an upper portion of the second barrier segment 406.

Additionally, the first end 458 of the second barrier segment 406 may be a first height and the second end 460 of the second barrier segment 406 may be a second height which is lesser than the height of the first end 458 (i.e., the top portion 444 of the second barrier segment 404 is sloped from the first end 458 to the second end 460). Furthermore, in some examples, an external surface on the second barrier segment 406 may define an internal cavity 421 such that the second barrier segment 406 is hollow.

In some example embodiments, the second barrier segment 406 may include one or more upper channels 406A near an upper portion of the second barrier segment 406. The upper channels may extend from a first end 458 of the second barrier segment 406 to a second end 460 of the second barrier segment 406. In some examples, the upper channels 406A may be substantially rectangular. Alternatively, the upper channels 406A may be substantially cylindrical. Many other examples are possible.

The second barrier segment 406 may also include one or more apertures 428 in an upper portion of the second barrier segment 406. In example embodiments, the apertures 428 provide access to the internal cavity of the second barrier segment 406 such that the second barrier segment 406 may be filled with a fill material (i.e., the apertures 428 can be used as a fill port). As shown in FIG. 4A, in some embodiments, the aperture or apertures 428 may be located on the top of the second barrier segment 406. Alternatively, the apertures 428 may be located on the first lateral side 462, the second lateral side 464, the first end 458, or the second end 460 of the second barrier segment 406. In some examples, the apertures 428 may also include a cap (not shown). The cap may provide a seal for the internal cavity of the second barrier segment 406 from an external environment. Additionally, the fill material may include, for example, water, sand, or concrete.

Additionally or alternatively, equipment may be placed in the aperture or apertures 428 such that the equipment extends from the internal cavity of the second barrier segment 406 to an external environment. In one example, the equipment can be coupled to the fill material in the internal cavity to assist in stabilizing the equipment on the second barrier segment 406. Equipment may include, for example, any combination of one or more of an atmospheric detection device, a radar detection device, a vehicle counting device, or a road traffic control device (e.g., a stop sign, a traffic light, a construction sign, etc.). Many other examples of equipment are possible.

Additionally, the second barrier segment 406 may include one or more recessed pockets 432 at a lower portion of the first lateral side 462 of the second barrier segment 406 and/or the second lateral side 464 of the second barrier segment 406. In some examples, the recessed pocket(s) 432 may be substantially rectangular or trapezoidal near the exterior surface of the second barrier segment 406. Additionally, the recessed pocket 432 may be narrower near the center of the second barrier segment 406 (i.e., the back of the recessed pocket 432). The recessed pockets 432 can help prevent distention of the second barrier segment 406 while the second barrier segment 406 is filled with fill material. Further, the recessed pockets 432 can help drain excess water or snow from a road way.

Within examples, the second barrier segment 406 can each be a monolithic structure (e.g., made from a single part construction). This can help to mitigate (or prevent) distention of the second barrier segment 406 while filling the second barrier segment 406 with the fill material.

In examples where the second barrier segment 406 is attached to the second member 212 via the second fastener 216 and the fourth fastener 422, rotation of the second member 212 about an axis 226 of the central member 208 affects placement of the second barrier segment 406 within the road barrier system 100. Additionally, this may affect placement of other barrier segments coupled to the second barrier segment 406 in the road barrier system 100. For example, the corner barrier segment 202 may be in a first configuration where the first member 210 and the second member 212 define a first angle 234 about the central member 208. The first member 210 may be rotated to a second configuration defining a second angle 236, different from the first angle 234, about the central member 208. This is can help arrange the road barrier system 100 around obstacles (e.g., a light post, a traffic sign, a tree, etc.).

The top portion 444 of the second barrier segment 404 may be sloped from the first end 458 to the second end 460. The sloped second barrier segment 404 can help reduce severity of the impact of a car colliding with the second barrier segment 404.

In the examples described previously, the first barrier segment 304 is a non- sloped segment and the second barrier segment 406 is a sloped segment. Many other arrangements and configurations are possible. For example, both the first barrier segment 304 and the second barrier segment 406 may be sloped segments. Alternatively, both the first barrier segment 304 and the second barrier segment 406 may be non-sloped segments.

C. Example Road Barrier Systems

Referring to FIGS. 5A-5B, a road barrier system 500 is illustrated according to an example embodiment, Specifically, FIG. 5A illustrates an elevation view of a road barrier system 500 and FIG. 5B illustrates a top view of a road barrier system 500.

As illustrated in FIGS. 5A and 5B, an example road barrier system 500 may include a combination of a corner barrier segment 502, a first barrier segment 504, and a plurality of barrier segments 568-580. A road barrier system 500 may comprise any number or combinations of different barrier segments. The corner barrier segments 502, first barrier segment 504, and additional barrier segments 568-580 may be affixed to one another using any of the fastening devices and methods described herein. As described previously, any barrier segment, sloped or flat, may be affixed to any other barrier segment.

As shown in FIGS. 5A-5B, the road barrier system 500 can be configured such that the height of the barrier system 500 gradually slopes down to the roadway. For instance, in one implementation, the barrier system 500 can slope down to approximately 11.5 centimeters from the ground. This can help to improve safety relative to other barrier systems. For instance, when a barrier system terminates in a segment having a relatively high height, a car that is incident on that segment may be arrested abruptly and, thus, a relatively large force may be applied to the car and its passengers. By contrast, because the road barrier system 500 slopes down to the roadway, a car incident on the road barrier system 500 can be permitted to more gradually come to a halt and, thus, the road barrier system 500 described herein can more safely arrest the motion of the car (reducing the force on the car and its passengers).

In an example, adjacent ends of each pair of barrier segments 568-580 have approximately the same height. Additionally, within examples, the corner barrier segment 502 can be attached to a second barrier segment (not shown in FIGS. 5A-5B). Also, within examples, the corner barrier segment 502 can be coupled to another corner barrier segment 502. This can help to provide greater flexibility and/or angles in positioning the barrier segments 502, 504, 568-580.

D. Example Fasteners

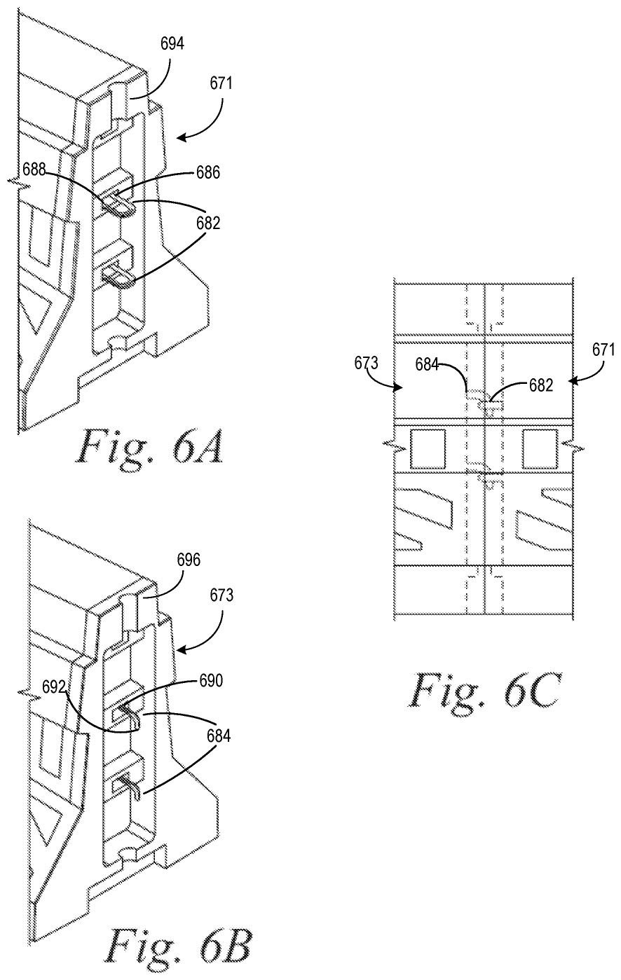

Referring to FIGS. 6A-6C, a pair of adjacent barrier segments 671, 673 that are coupled to each other by a plurality of fasteners are shown according to an example embodiment. Specifically, FIG. 6A illustrates an isometric view of a barrier segment 671 including a receptacle fastener 682, FIG. 6B illustrates an isometric view of a barrier segment 673 including a hook fastener 684, and FIG. 6C illustrates an elevation view of the receptacle fastener 682 retaining the hook fastener 684 to couple the barrier segments 671, 673 to each other. The barrier segments 671, 673 can be similar or identical to any of the barrier segments described herein (e.g., the corner barrier segments 102, 202, 502, the first barrier segments 104, 304, 504, the second barrier segments 106, 406, and/or the barrier segments 568-580). Accordingly, the example fasteners illustrated in FIGS. 6A-6C and described in detail below may apply to any of the fasteners on any of the barrier segments described herein.

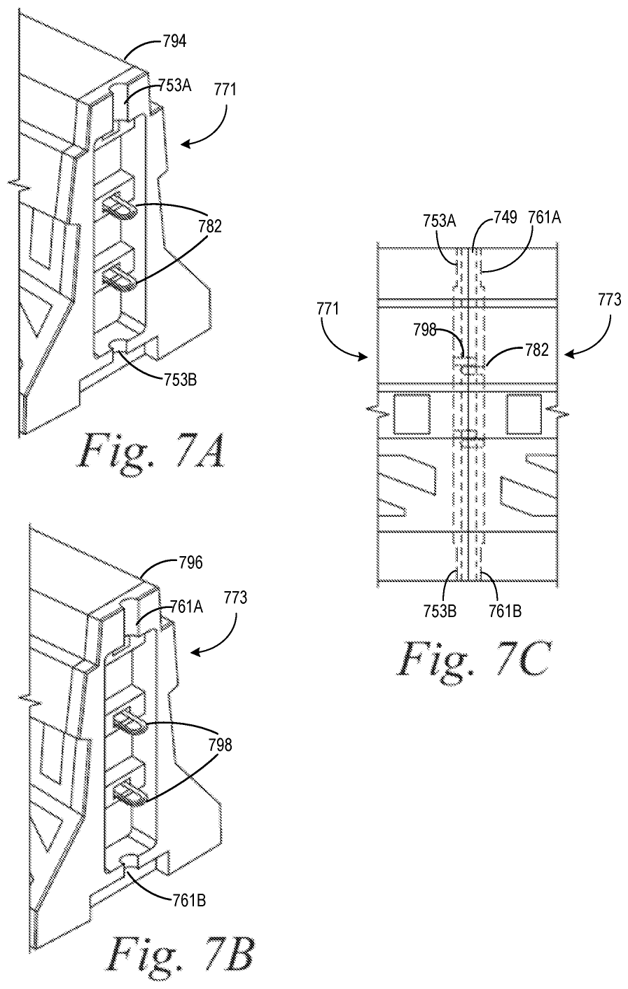

As shown in FIG. 6A, the receptacle fastener 682 can include a first end 686 and second end 688 that are each attached to a lateral side 694 of the barrier segment 671 (i.e., forming a loop or a U-shaped member). As described below, the receptacle fastener 682 can be configured to receive and retain the hook fastener 684. Additionally, as described below with respect to FIGS. 7A-7C, the receptacle fastener 682 can additionally or alternatively be configured to receive and retain a bar or rod (e.g., the bolt 249 in FIG. 2G).

As shown in FIG. 6B, the hook fastener 684 includes a first end 690 and a second end 692. The first end 690, for example, may be coupled to a lateral side 696 of the barrier segment 673 and the second end 692 may extend from the lateral side 696 of the barrier segment 673. The hook fastener 684 is configured to extend through the receptacle fastener 682.

In FIG. 6C, the barrier segment 671 is coupled to the barrier segment 673 by the receptacle fastener 682 receiving and retaining the hook fastener 684. As shown in FIG. 6C, the hook fastener 684 can extend into a recessed portion of the lateral side 694 of the barrier segment 671, and the receptacle fastener 682 can extend into a recessed portion of the lateral side 696 of the barrier segment 673. As such, the recessed portions can facilitate coupling the barrier segments 671, 673 relatively close to each other.

In examples in which a barrier segment includes two or more fasteners on a lateral side, the fasteners may be of the same type or different types. Additionally, a barrier segment can have the same type or different types of fasteners on the lateral sides. For instance, the third fastener 318 on the first end 358 of the first barrier segment 304 may be a hook fastener 684 and the fifth fastener 320 on the second end 360 of the first barrier segment 304 may be a receptacle fastener 682. Alternatively, for example, both the third fastener 318 and the fifth fastener 320 may be hook fasteners 684.

Referring to FIGS. 7A-7C, a pair of adjacent barrier segments 771, 773 that are coupled to each other by a plurality of fasteners 782, 798 and a bolt 749 are shown according to another example embodiment. Specifically, FIG. 7A illustrates an isometric view of a barrier segment 771 including a receptacle fastener 782, FIG. 7B illustrates an isometric view of a of a barrier segment 773 including a receptacle fastener 798, and FIG. 7C illustrates an elevation view of the receptacle fastener 782 and the receptacle fastener 798 retaining a bolt 749 to couple the barrier segments 771, 773 to each other. The barrier segments 671, 673 can be similar or identical to any of the barrier segments described herein (e.g., the corner barrier segments 102, 202, 502, the first barrier segments 104, 304, 504, the second barrier segments 106, 406, and/or the barrier segments 568-580). Accordingly, the example fasteners illustrated in FIGS. 7A-7C and described in detail below may apply to any of the fasteners on any of the barrier segments described herein.

As shown in FIGS. 7A-7B, the receptacle fasteners 782, 798 can be substantially similar or identical to the receptacle fasteners described above (e.g., the receptacle fastener 682). Additionally, as shown in FIGS. 7A-7B, the barrier segment 771 includes a top groove 753A and a bottom groove 753B and the barrier segment 773 includes a top groove 761A and a bottom groove 761B.

As shown in FIG. 7C, the receptacle fasteners 782 on the barrier segment 771 can be at respective heights that are offset relative to the receptacle fasteners 798 on the barrier segment 773. As such, when the barrier segments 771 positioned adjacent to the barrier segment 773, the receptacle fasteners 782 overlap with the receptacle fasteners 798. In this arrangement, a passage is formed by through the top grooves 753A, 761A, the receptacle fasteners 782, 798, and the bottom grooves 753B, 761B. The bolt 749 can be inserted and retained in the passage to couple the barrier segment 771 to the barrier segment 773. In other words, the bolt 749 can be inserted vertically between the top groove 753A of the barrier segment 771 and the top groove 761A of the barrier segment 773, the receptacle fastener 782 and the receptacle fastener 798, and the bottom groove 753B of the first barrier segment 771 and the bottom groove 761B of the second barrier segment 773.

Also, as shown in FIG. 7C, the receptacle fastener 798 can extend into a recessed portion of the lateral side of the barrier segment 771, and the receptacle fastener 782 can extend into a recessed portion of the barrier segment 773. As such, the recessed portions can facilitate coupling the barrier segments 771, 773 relatively close to each other.

E. Example Equipment

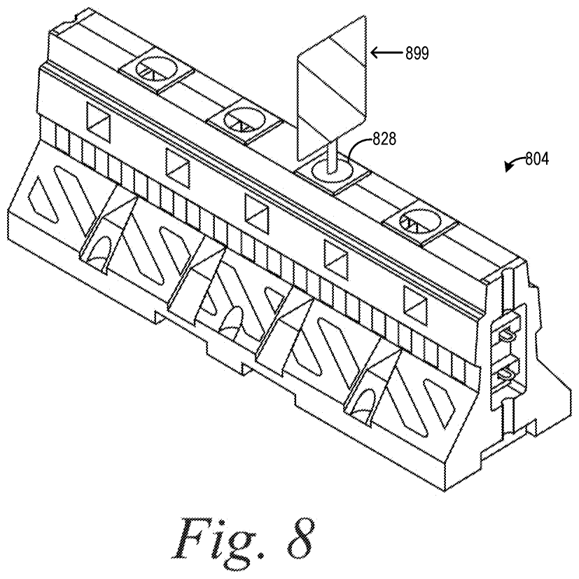

Referring to FIG. 8, equipment 899 coupled to a barrier segment 804 according to an example embodiment. In some examples, the equipment 899 may be placed in an aperture 828 of the barrier segment 804 such that the equipment 899 extends from an internal cavity of the barrier segment 804 to an external environment. In one example, the equipment 899 can be coupled to a fill material in the internal cavity to assist in stabilizing the equipment 899 on the barrier segment 804. The equipment 899 can include, for example, one or more atmospheric detection devices, radar detection devices, vehicle counting devices, and/or road traffic control devices (e.g., a stop sign, a traffic light, a construction sign, etc.). Many other examples of equipment are possible.

III. Example Methods

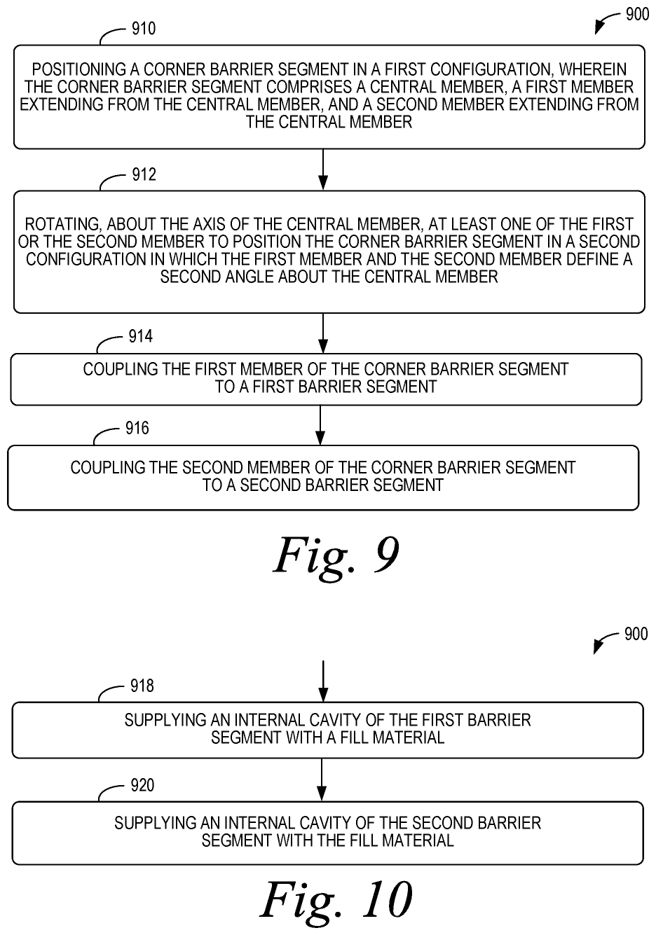

Referring now to FIG. 9, a flowchart for a process 900 for assembling a barrier system is illustrated according to an example. As shown in FIG. 9, at block 910, the process 900 includes positioning a corner barrier segment in a first configuration. The corner barrier segment includes a central member, a first member extending from the central member, and a second member extending from the central member. The first member includes a first fastener and the second member includes a second fastener. The first member and the second member define a first angle about the central member.

At block 912, the process 900 includes rotating, about the axis of the central member, at least one of the first or the second member to position the corner barrier segment in a second configuration in which the first member and the second member define a second angle about the central member. The first angle is different than the second angle. At block 914, the process 900 includes coupling the first member of the corner barrier segment to a first barrier segment. At block 916, the process 900 includes coupling the second member of the corner barrier segment to a second barrier segment.

FIGS. 10-13 depict additional aspects of the process 900 according to further examples. As shown in FIG. 10, the process 900 can include supplying an internal cavity of the first barrier segment with a fill material at block 918. At block 920, the process 900 can include supplying an internal cavity of the second barrier segment with the fill material.

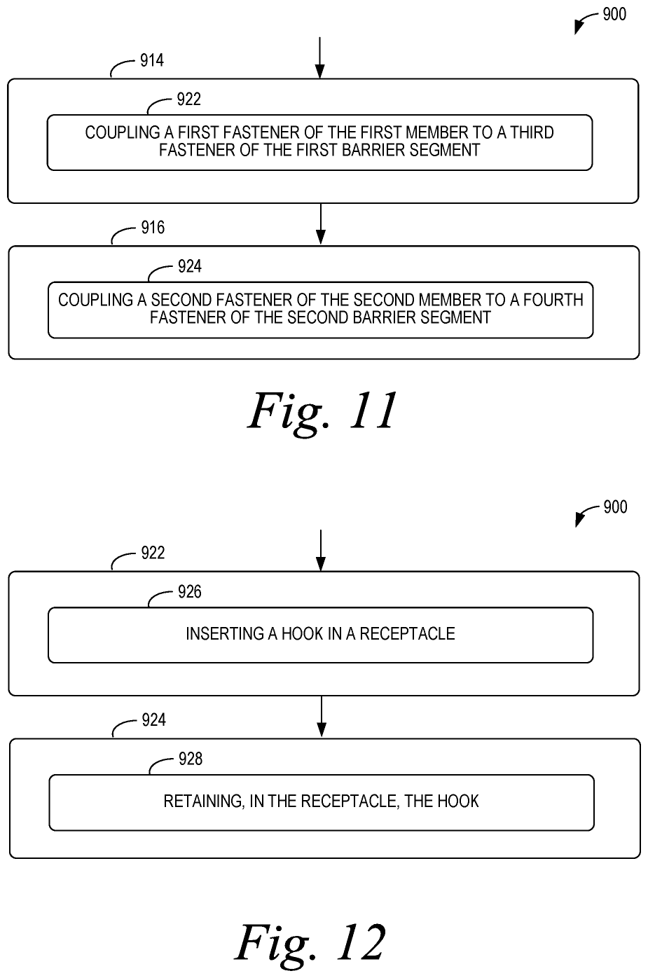

As shown in FIG. 11, coupling the first member of the corner barrier segment to the first barrier segment at block 914 can include coupling a first fastener of the first member to a third fastener of the first barrier segment at block 922. As also shown in FIG. 11, coupling the second member to the corner barrier segment at block 916 can include coupling a second fastener of the second member to a fourth fastener of the second barrier segment at block 924.

As shown in FIG. 12, coupling the first fastener of the first member to the third fastener of the first barrier segment at block 922 can include inserting a hook in a receptacle at block 926. Coupling the second fastener of the second member to the fourth fastener of the second barrier segment can at block 924 can include retaining, in the receptacle, the hook at block 926.

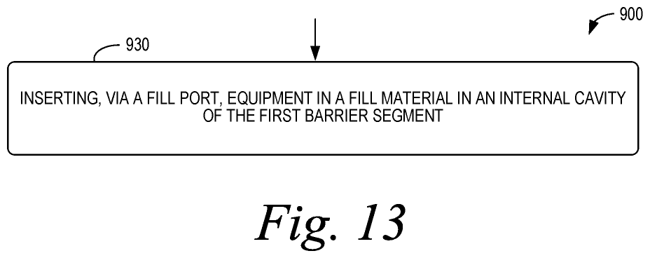

As shown in FIG. 13, the process 900 can include inserting, via a fill port, equipment in a fill material in an internal cavity of the first barrier segment at block 930. The equipment can extend from the internal cavity to an environment external to the first barrier segment.

IV. Conclusion

The description of the different advantageous arrangements has been presented for purposes of illustration and description, and is not intended to be exhaustive or limited to the embodiments in the form disclosed. Many modifications and variations will be apparent to those of ordinary skill in the art. Further, different advantageous embodiments may describe different advantages as compared to other advantageous embodiments. The embodiment or embodiments selected are chosen and described in order to explain the principles of the embodiments, the practical application, and to enable others of ordinary skill in the art to understand the disclosure for various embodiments with various modifications as are suited to the particular use contemplated.

1. A barrier system, comprising:
a corner barrier segment, wherein the corner barrier segment comprises:
a central member comprising a pin extending along an axis,
a first member coupled to the central member, wherein the first member comprises:
a first fastener at a first end of the first member,
a first arm portion defining a first bore substantially surrounding the central member at a second end of the first member, wherein the first bore extends in a direction of the axis of the central member, and
a substantially rectangular portion between the first end and the second end of the first member; and
a second member coupled to the central member, wherein the second member comprises:
a second fastener at a first end of the second member,
a second arm portion defining a second bore substantially surrounding the central member at a second end of the second member, wherein the second bore extends in the direction of the axis of the central member, and
a substantially rectangular portion between the first end and the second end of the second member,
wherein the central member extends through the first bore of the first arm portion and the second bore of the second arm portion such that the first member and the second member are configured to rotate, about the axis of the central member, relative to each other;
a first barrier segment coupled to the first fastener via a third fastener on a first end of the first barrier segment; and
a second barrier segment coupled to the second fastener via a fourth fastener on a first end of the second barrier segment,
wherein the first barrier segment and the second barrier segment are hollow, wherein the first barrier segment comprises a first aperture at an upper portion of the first barrier segment,
wherein the second barrier segment comprises a second aperture at an upper portion of the second barrier segment, and
wherein the first aperture and the second aperture provide access to an internal cavity of the first barrier segment and an internal cavity of the second barrier segment, respectively.

2. (canceled)

3. The barrier system of claim 1, wherein the internal cavity of the first barrier segment and the internal cavity of the second barrier segment comprise at least one material selected from a group consisting of concrete, water, and sand.

4. (canceled)

5. (canceled)

6. The barrier system of claim 1, wherein the first fastener comprises a receptacle, wherein the receptacle comprises a first end and a second end, and wherein the first end and the second end of the receptacle are coupled to the first member.

7. The barrier system of claim 6, wherein the third fastener on the first end of the first barrier segment comprises a hook, wherein the receptacle is configured to receive and retain the hook.

8. The barrier system of claim 6, wherein the first end of the first barrier segment is a first height, wherein the second end of the first barrier segment is a second height, wherein the first height is greater than the second height, and wherein a top portion of the first barrier segment is sloped from the first end to the second end.

9. The barrier system of claim 1, wherein in the central member is substantially cylindrical.

10. The barrier system of claim 1, wherein a second end of the first barrier segment comprises a fifth fastener, and wherein the fifth fastener is coupled to a third barrier segment via a sixth fastener on a first end of the third barrier segment.

11. The barrier system of claim 1, wherein the first barrier segment comprises at least one channel at an upper portion of the first barrier segment, and wherein the second barrier segment comprises at least one channel at an upper portion of the second barrier segment.

12. The barrier system of claim 11, wherein the at least one channel in the first barrier segment and the at least one channel in the second barrier segment are substantially rectangular.

13. The barrier system of claim 1, wherein an exterior of the first barrier segment comprises:
at least one recessed pocket at a lower portion of a first side of the first barrier segment; and
at least one recessed pocket at a lower portion of a second side of the first barrier segment.

14. The barrier system of claim 1, wherein the first barrier segment comprises:
an internal cavity; and
equipment, wherein the equipment extends from the internal cavity to an environment external to the first barrier segment, and wherein the equipment comprises at least one of an atmospheric detection device, a radar detection device, a vehicle counting device, or a road traffic control device.

15. A method comprising:
positioning a corner barrier segment in a first configuration, wherein the corner barrier segment comprises:
a central member, comprising a pin extending along an axis,
a first member comprising a first fastener at a first end of the first member, wherein the first member comprises a first arm portion first arm portion defining a first bore substantially surrounding the central member at a second end of the first member, wherein the first bore extends in a direction of the axis of the central member, and wherein the first member comprises a substantially rectangular portion between the first end and the second end of the first member,
a second member comprising a second fastener at a first end of the second member, wherein the second member comprises a second arm portion defining a second bore substantially surrounding the central member at a second end of the second member, wherein the second bore extends in the direction of the axis of the central member, and wherein the second member comprises a substantially rectangular portion between the first end and the second end of the second member,
wherein the central member extends through the first bore of the first arm portion and the second bore of the second arm portion such that the first member and the second member are configured to rotate, about the axis of the central member, relative to each other,
wherein, in the first configuration, the first member and the second member define a first angle about the central member;
wherein the first barrier segment and the second barrier segment are hollow;
wherein the first barrier segment comprises a first aperture at an upper portion of the first barrier segment;
wherein the second barrier segment comprises a second aperture at an upper portion of the second barrier segment, and
wherein the first aperture and the second aperture provide access to an internal cavity of the first barrier segment and an internal cavity of the second barrier segment, respectively;
rotating, about the axis of the central member, at least one of the first or the second member to position the corner barrier segment in a second configuration in which the first member and the second member define a second angle about the central member, wherein the first angle is different than the second angle;
coupling the first member of the corner barrier segment to a first barrier segment; and
coupling the second member of the corner barrier segment to a second barrier segment.

16. The method of claim 15, further comprising:
supplying an internal cavity of the first barrier segment with a fill material; and
supplying an internal cavity of the second barrier segment with the fill material.

17. The method of claim 15, wherein coupling the first member of the corner barrier segment to the first barrier segment comprises coupling a first fastener of the first member to a third fastener of the first barrier segment, and
wherein coupling the second member of the corner barrier segment to the second barrier segment comprises coupling a second fastener of the second member to a fourth fastener of the second barrier segment.

18. The method of claim 15, wherein the first fastener comprises a receptacle, wherein the receptacle comprises a first end and a second end and wherein the first end and the second end of the receptacle are coupled, wherein the second fastener comprises a hook, and wherein fastening via the first fastener, the first member of the corner barrier segment to the second fastener further comprises:
inserting the hook in the receptacle;
retaining, in the receptacle, the hook.

19. The method of claim 15, further comprising:
inserting, via a fill port, equipment in a fill material in an internal cavity of the first barrier segment, wherein the equipment extends from the internal cavity to an environment external to the first barrier segment.

20. The method of claim 19, wherein the equipment comprises at least one of an atmospheric detection device, a radar detection device, a vehicle counting device, or a road traffic control device.

21. The barrier system of claim 1, wherein the first fastener comprises a plurality of loops, each loop of the plurality of loops comprising an aperture, wherein the first member comprises a top groove and a bottom grove, and wherein the top groove and the bottom groove axially align with the apertures of plurality of loops.

22. The barrier system of claim 21, wherein the plurality of loops is a first plurality of loops, wherein the third fastener comprises a second plurality of loops, each loop comprising an aperture, and wherein the apertures of the first plurality of loops axially aligns with the apertures of the second plurality of loops.

23. The barrier system of claim 22, wherein the first plurality of loops is at a first recessed portion of the first member, and wherein the second plurality of loops is at a second recessed portion of the first barrier segment.
